(19) United States
(12) Patent Application Publication
(10) Pub. No.: US 2026/0022989 A1
(43) Pub. Date: Jan. 22, 2026

(54) ROLLING TEST DEVICE FOR FLEXIBLE MATERIAL

(71) Applicant: FlexiGO INC., Cheonan-si (KR)

(72) Inventors: Ki Yong LEE, Cheonan-si (KR); Seong Woo KIM, Cheonan-si (KR); Ho Moon YOU, Cheongju-si Chungcheongbuk-do (KR)

(21) Appl. No.: 18/774,847

(22) Filed: Jul. 16, 2024

(51) Int. Cl. G01M 5/00

(52) U.S. Cl. CPC G01M 5/0075

(57) ABSTRACT

A rolling test device for flexible materials includes a rolling unit composed of a winding roller that grips a first side of a flexible material, and a winding drive part that rotates the winding roller forwards and backwards so that the flexible material is wound on the winding roller or the flexible material is unwound from the winding roller, a sliding unit that grips a second side of the flexible material, is spaced apart from the winding roller, and slidably moves the flexible material according to rotation of the winding roller, a lifting unit that moves the rolling unit up and down, and a control unit that controls operations of the rolling unit, the sliding unit, and the lifting unit according to the rotation of the winding roller so that an inclination of the flexible material is adjusted between the rolling unit and the sliding unit.

### BACKGROUND

### 1. Technical Field

The present disclosure relates to a rolling test device for flexible materials, which prevents a flexible material from tilting between a sliding unit and a rolling unit and ensures that the tensile force applied to the flexible material is consistent when performing a rolling test of the flexible material.

### 2. Description of the Related Art

In general, liquid crystal displays (LCDs), organic light emitting diodes (OLEDs), and electroluminescent (EL) displays, which are types of flat panel displays (FPDs), have low power consumption, are lightweight, and are flat c, and thus are widely used in monitors for televisions, computers, mobile phones, automobiles, and aircraft.

Recently, the display industry has been actively developing flexible displays. As performance and quality improve, these flexible displays should not only be able to bend, but also have durability and operating stability that can withstand bending beyond a certain level. More precisely, a flexible display should be able to display normal images both in a bent or rolled state and in an unfolded state. In this way, the degree to which a flexible display can bend within the range in which it can display normal images, that is, the bending characteristic (flexibility), is one of the most important performances of a flexible display.

As the performance and quality of flexible displays improve, research and development on display-related technologies, such as a foldable display technology that allows a display to be completely folded or unfolded, a slidable display technology that allows a display to be slid, and a rollable display technology that allows a display to be rolled up, is being actively conducted, and commercialization based on the results of research and development is also being actively conducted.

In particular, when testing the durability of rollable displays during the development process of rollable display technology, the tensile force applied to a rollable display is one of the factors that has the greatest impact on the test. In order to derive fair and consistent test evaluation results, the tensile force applied to a flexible material must be set consistently.

However, when conducting rolling tests of flexible materials, as a flexible material is wound around a rolling unit, the diameter of the rolling unit increases and the flexible material tilts, and the tilt of the flexible material causes a significant difference in the durability evaluation of the flexible material, which is problematic.

### Document of Related Art

(Patent Document 1) Korean Patent No. 10-2348742, “ROLLING DEVICE FOR DURABILITY EVALUATION OF FLEXIBLE MATERIAL AND EVALUATION SYSTEM” (Announced Jan. 7, 2022)

### SUMMARY

Accordingly, the present disclosure has been made keeping in mind the above problems occurring in the related art, and the present disclosure is intended to provide a rolling test device for flexible materials, which prevents a flexible material from tilting between a sliding unit and a rolling unit and ensures that the tensile force applied to the flexible material is consistent when performing a rolling test of the flexible material.

In order to achieve the above objective, according to a preferred embodiment of the present disclosure, there is provided a rolling test device for flexible materials including: a rolling unit composed of a winding roller that grips a first side of a flexible material, and a winding drive part that rotates the winding roller forwards and backwards so that the flexible material is wound on the winding roller or the flexible material is unwound from the winding roller; a sliding unit that grips a second side of the flexible material, is spaced apart from the winding roller, and slidably moves the flexible material according to rotation of the winding roller; a lifting unit that moves the rolling unit up and down; and a control unit that controls operations of the rolling unit, the sliding unit, and the lifting unit according to the rotation of the winding roller so that an inclination of the flexible material is adjusted between the rolling unit and the sliding unit.

As a result, the initial setting of a flexible material may be clearly established, the operations of the rolling unit, the sliding unit, and a lifting unit may be clearly linked, and wrinkling of the flexible material may be prevented.

In this case, the sliding unit may include: a sliding guide disposed spaced apart from the winding roller; a grip slider coupled to the sliding guide to be able to move slidably; a detachable member that is provided on the grip slider and grips the second side of the flexible material; and a sliding drive part that slidably moves the grip slider on the sliding guide according to the rotation of the winding roller.

As a result, it is possible to maintain a flexible material in a taut state, and to stably implement the rolling motion of the flexible material and the unrolling motion of the flexible material.

In this case, the lifting unit may include: a ball screw disposed spaced apart from the rolling unit and formed long along a lifting and lowering movement direction of the winding roller; a screw driving part that rotates the ball screw forwards and backwards so that the winding roller moves up and down; a lifting member screw-coupled to the ball screw; and a lifting bracket that combines the rolling unit and the lifting member.

As a result, since a winding roller moves up and down in conjunction with the operations of the rolling unit and the sliding unit, tilting of a flexible material between the rolling unit and the sliding unit may be minimized or prevented, and the tensile force applied to the flexible material may be set consistently.

In this case, the control unit may include: a condition input part where a length of the flexible material, a thickness of the flexible material, and a diameter of the winding roller are input as condition information; a rotation number calculation part that calculates a rotation number of the winding roller on the basis of the condition information; a rolling distance calculation part that uses the condition information and the rotation number to calculate a rolling distance at which the second side of the flexible material slides by the sliding unit according to the rotation number; a lifting distance calculation part that uses the condition information and the rotation number to calculate a lifting distance by which the winding roller moves up and down according to the rotation number; and a drive control part that controls the operations of the rolling unit, the sliding unit, and the lifting unit using the rotation number, the rolling distance, and the lifting distance so that the inclination of the flexible material is adjusted between the rolling unit and the sliding unit.

As a result, the winding roller may be changed in various ways depending on a flexible material to be tested, and by interlocking the rolling unit, the sliding unit, and the lifting unit, the rotation of the winding roller, the lifting movement of the winding roller, and the sliding movement of a flexible material may be clearly performed, while improving the accuracy of the test results.

According to the present disclosure, a rolling test device for flexible materials, which can prevent a flexible material from tilting between a sliding unit and a rolling unit and ensure that the tensile force applied to the flexible material is consistent when performing a rolling test of the flexible material, can be implemented.

Furthermore, according to the present disclosure, a flexible material can be continuously maintained in a flat state, the tension of the flexible material can be adjusted, and uniform tension can be applied to the flexible material.

Furthermore, according to the present disclosure, the initial setting of a flexible material can be clearly established, the operations of the rolling unit, the sliding unit, and a lifting unit can be clearly linked, and wrinkling of the flexible material can be prevented.

Furthermore, according to the present disclosure, it is possible to maintain a flexible material in a taut state, and to stably implement the rolling motion of the flexible material and the unrolling motion of the flexible material.

Furthermore, according to the present disclosure, since a winding roller moves up and down in conjunction with the operations of the rolling unit and the sliding unit, tilting of a flexible material between the rolling unit and the sliding unit can be minimized or prevented, and the tensile force applied to the flexible material can be set consistently.

Furthermore, according to the present disclosure, the winding roller can be changed in various ways depending on a flexible material to be tested, and by interlocking the rolling unit, the sliding unit, and the lifting unit, the rotation of the winding roller, the lifting movement of the winding roller, and the sliding movement of a flexible material can be clearly performed, while improving the accuracy of the test results.

Furthermore, according to the present disclosure, intermittent rotation of the winding roller can be implemented depending on the rotation number of the winding roller, the change in inclination of a flexible material can be predicted in response to the thickness of the flexible material, and the test results can be easily corrected according to the inclination of the flexible material.

Furthermore, according to the present disclosure, continuous rotation of the winding roller can be implemented depending on the rotation number of the winding roller, the flatness of the initially set flexible material can be maintained stably, and the test results according to the inclination of the flexible material can be easily corrected.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view showing a rolling test device for flexible materials according to an embodiment of the present disclosure;

FIG. 2 is a view showing the operation of a control unit in a rolling test device for flexible materials according to an embodiment of the present disclosure;

FIG. 3 is a view showing the operation of a lifting unit when a winding roller is rotated intermittently according to the number of rotations in a rolling test device for flexible materials according to an embodiment of the present disclosure; and

FIG. 4 is a view showing the operation of a lifting unit when a winding roller is rotated continuously according to the number of rotations in a rolling test device for flexible materials according to an embodiment of the present disclosure.

### DETAILED DESCRIPTION

The above objectives, other objectives, features and advantages of the present disclosure can be easily understood through the following preferred embodiments related to the attached drawings. However, the present disclosure is not limited to the embodiments described herein and may be embodied in other forms. Rather, the embodiments introduced herein are provided so that the present disclosure will be thorough and complete, and will fully convey the spirit of the present disclosure to those skilled in the art.

In this specification, when a component is referred to as being on another component, it means that it may be formed directly on the other component or that a third component may be interposed between them. Additionally, in the drawings, the thickness of components may be exaggerated for effective explanation of technical content.

When terms such as first, second, etc. are used in this specification to describe components, these components should not be limited by these terms. These terms are merely used to distinguish one component from another. The embodiments described and illustrated herein also include complementary embodiments thereof.

In addition, when it is said that a first element (or component) is operated or executed on a second element (or component), it should be understood that the first element (or component) operates or runs in an environment in which the second element (or component) operates or runs, or the second element (or component) operates or runs through direct or indirect interaction.

When any element, component, device or system is said to contain a component consisting of a program or software, it should be understood, even without explicit mention, that the element, component, device or system includes hardware (e.g., memory, CPU, etc.) necessary for the program or software to run or operate, or other programs or software (e.g., drivers required to run an operating system or the hardware, etc.).

In addition, when an element (or component) is implemented, unless otherwise specified, it should be understood that the element (or component) can be implemented in any form of software, hardware, or software and hardware.

In addition, the terminology used herein is for the purpose of describing the embodiments and is not intended to limit the present disclosure. In this specification, singular forms also include plural forms unless specifically stated in the phrase. As used in the specification, “comprises” and/or “comprising” does not exclude the presence or addition of one or more other components.

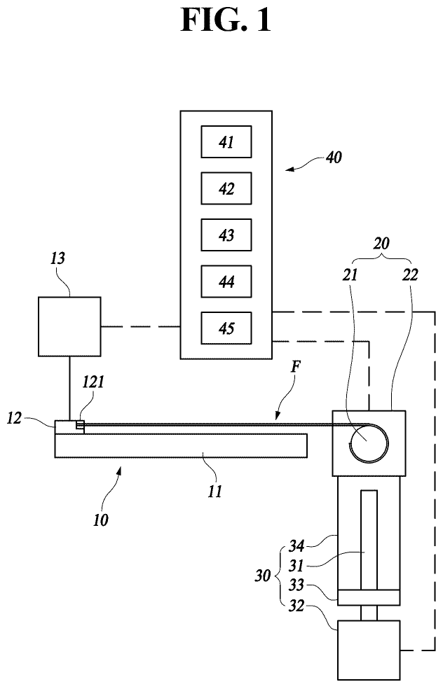

Referring to FIGS. 1 to 4, a rolling test device for flexible materials according to an embodiment of the present disclosure may include a rolling unit 20, a sliding unit 10, a lifting unit 30, and a control unit 40.

The rolling unit 20 grips one side of a flexible material and rolls the flexible material or unwinds the flexible material.

The rolling unit 20 may include: a winding roller 21 that grips one side of the flexible material; and a winding drive part 22 that rotates the winding roller 21 forwards and backwards so that the flexible material is wound on the winding roller 21 or the flexible material is unwound from the winding roller 21. The diameter of the winding roller 21 may be changed in various ways depending on the length of a flexible material to be tested, the thickness of a flexible material to be tested, etc., and the winding roller 21 may be detachably coupled to the winding drive part 22.

The sliding unit 10 grips the other side of the flexible material, is spaced apart from the winding roller 21, and slidably moves the flexible material according to the rotation of the winding roller 21.

The sliding unit 10 may include: a sliding guide 11 disposed spaced apart from the winding roller 21 of the rolling unit 20; a grip slider 12 coupled to the sliding guide 11 to be able to move slidably; a detachable member 121 that is provided on the grip slider 12 and grips the other side of the flexible material; and a sliding drive part 13 that slidably moves the grip slider 12 on the sliding guide 11 according to the rotation of the winding roller 21 of the rolling unit 20.

According to the operation of the rolling unit 20, the sliding unit 10 adjusts the sliding movement speed of the flexible material, so that the flexible material may be maintained in a stable and flat state.

Although not shown, the sliding unit 10 may slidably move the grip slider 12 using a ball screw method. The sliding unit 10 may further include a screw member that is rotated forwards and backwards by the sliding drive part 13 and is screwed to the grip slider 12. Then, since the rotational motion of the screw member is converted into the linear motion of the grip slider 12, the grip slider 12 may be moved stably on the sliding guide 11. The screw member operates with a ball screw 31, which will be described later, and the grip slider 12 operates with a lifting member 33, which will be described later.

The lifting unit 30 moves the rolling unit 20 up and down.

The lifting unit 30 may include: the ball screw 31 arranged to be spaced apart from the rolling unit 20 and formed long along the lifting and lowering movement direction of the winding roller 21; a screw driving part 32 that rotates the ball screw 31 forwards and backwards so that the winding roller 21 moves up and down; the lifting member 33 screw-coupled to the ball screw 31; and a lifting bracket 34 that combines the rolling unit 20 and the lifting member 33.

Then, since the rotational motion of the ball screw 31 is converted into the linear motion of the lifting member 33, the winding roller 21 may be moved up and down stably.

The control unit 40 controls the operations of the rolling unit 20, the sliding unit 10, and the lifting unit according to the rotation of the winding roller 21 so that the inclination of the flexible material is adjusted between the rolling unit 20 and the sliding unit 10.

The control unit 40 may include: a condition input part 41 where the length of a flexible material, the thickness of the flexible material, and the diameter of the winding roller 21 are input as condition information; a rotation number calculation part 42 that calculates the rotation number of the winding roller 21 using the condition information; a rolling distance calculation part 43 that uses the condition information and the rotation number to calculate a rolling distance at which the other side of the flexible material slides by the sliding unit 10 according to the rotation number; a lifting distance calculation part 44 that uses the condition information and the rotation number to calculate a lifting distance by which the winding roller 21 moves up and down according to the rotation number; and a drive control part 45 that controls the operations of the rolling unit, the sliding unit 10, and the lifting unit 30 using the rotation number, the rolling distance, and the lifting distance so that the inclination of the flexible material is adjusted between the rolling unit 20 and the sliding unit 10.

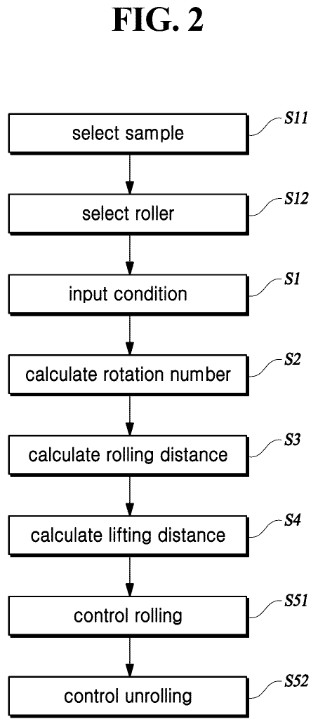

A method of controlling the rolling test device for flexible materials according to an embodiment of the present disclosure is as follows. As shown in FIG. 2, the control unit 40 may perform a condition input step (S1) as the length of a flexible material, the thickness of the flexible material, and the diameter of the winding roller 21 are input depending on a flexible material to be tested. Accordingly, condition information is input in the condition input step (S1). The condition input step (S1) may be performed by the operation of the condition input part 41. At this time, the condition information is the length of the flexible material, the thickness of the flexible material, and the diameter of the winding roller 21.

Prior to the condition input step (S1), the control unit 40 may perform a sample selection step (S11) and a roller selection step (S12) as a flexible material to be tested is selected, and the winding roller 21 is selected corresponding to the selected flexible material. Accordingly, in the sample selection step (S11), the flexible material to be tested may be selected and condition information may be extracted from information on the selected flexible material. In addition, in the roller selection step (S12), the winding roller 21 may be selected in response to the selected flexible material, and condition information may be extracted from information on the selected winding roller 21. In addition, the extracted condition information is input into the condition input part 41. The sample selection step (S11) and the roller selection step (S12) may be performed by the operation of the control unit 40.

Although not shown, prior to the condition input step (S1), the control unit 40 couples the selected winding roller 21 to the winding drive part 22, and as the condition input step (S1) is passed, the control unit 40 operates the sliding unit 10 and the lifting unit 30 based on the condition information, so that a setting step may be performed. Accordingly, in the setting step, the rolling unit 20, the sliding unit 10, and the lifting unit 30 may be set so that the flexible material is installed. The setting step may be performed by the operation of the control unit 40. To be specific, in the setting step, the control unit 40 operates the sliding unit 10 to space the detachable member 121 from the winding roller 21 in accordance with the length of the flexible material, and operates the lifting unit 30 to prevent a virtual line connecting the other side of the flexible material coupled to the detachable member 121 and the part of the flexible material in contact with the winding roller 21 from being tilted.

The above-mentioned setting step may be performed manually by an operator.

After the condition input step (S1), a rotation number calculation step (S2) may be performed as the control unit 40 calculates the rotation number of the winding roller 21 using the condition information. Accordingly, in the rotation number calculation step (S2), the rotation number is calculated using the condition information. The rotation number calculation step (S2) may be performed by the operation of the rotation number calculation part 42.

After the rotation number calculation step (S2), a first distance calculation step (S3) and a second distance calculation step (S4) may be performed as the control unit 40 calculates the rolling distance according to the rotation number using the condition information and the rotation number, and calculates the lifting distance according to the rotation number using the condition information and the rotation number. At this time, the order of the first distance calculation step (S3) and the second distance calculation step (S4) is not limited. That is, the second distance calculation step (S4) may be performed after the first distance calculation step (S3), the first distance calculation step (S3) may be performed after the second distance calculation step (S4), or the first distance calculation step (S3) and the second distance calculation step (S4) may be performed simultaneously. Accordingly, in the first distance calculation step (S3), the rolling distance is calculated based on the rotation number, whereas in the second distance calculation step (S4), the lifting distance is calculated based on the rotation number. The first distance calculation step (S3) may be performed by the operation of the rolling distance calculation part 43, and the second distance calculation step (S4) may be performed by the operation of the lifting distance calculation part 44. In this case, the rolling distance represents the distance that the other side of the flexible material slides by the sliding unit 10 depending on the rotation number, and the lifting distance represents the distance that the winding roller 21 moves up and down depending on the rotation number.

After the first distance calculation step (S3) and the second distance calculation step (S4), a first rolling control step (S51) may be performed as the control unit 40 operates the rolling unit 20, the sliding unit 10, and the lifting unit 30 using the calculated rotation number, the rolling distance, and the lifting distance so that the flexible material is wound around the winding roller 21. Accordingly, in the first rolling control step (S51), the rolling unit 20, the sliding unit 10, and the lifting unit 30 are operated using the calculated rotation number, the rolling distance, and the lifting distance so that the flexible material is wound around the winding roller 21. The first rolling control step (S51) may be performed by the operation of the drive control part 45.

In addition, after the first rolling control step (S51), a second rolling control step (S52) may be performed as the control unit 40 operates the rolling unit 20, the sliding unit 10, and the lifting unit 30 using the calculated rotation number, the rolling distance, and the lifting distance so that the flexible material is released from the winding roller 21. Accordingly, in the second rolling control step (S52), the rolling unit 20, the sliding unit 10, and the lifting unit 30 are operated using the calculated rotation number, the rolling distance, and the lifting distance so that the flexible material is released from the winding roller 21. The second rolling control step (S52) may be performed by the operation of the drive control part 45.

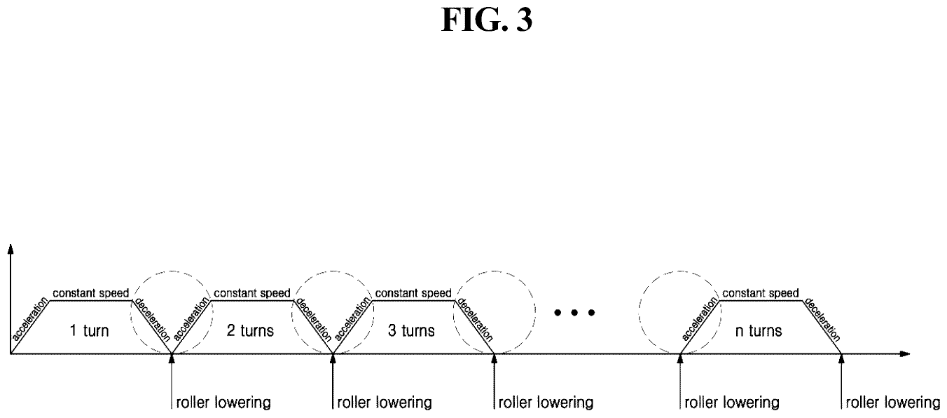

As an example, assuming that the calculated rotation number of the winding roller 21 is n turns, as shown in FIG. 3, in the first rolling control step (S51), the winding roller 21 intermittently rotates one turn at a time in accordance with the rotation number, the other side of the flexible material slides intermittently in response to the intermittent rotation of the winding roller 21, and the rolling unit 20 is intermittently lowered in response to the intermittent rotation of the winding roller 21. To be specific, in the first rolling control step (S51), the sliding unit 10 may intermittently move the other side of the flexible material toward the winding roller 21 in response to the operation of the rolling unit 20. In addition, in the first rolling control step (S51), the lifting unit 30 may intermittently lower the rolling unit in response to the thickness of the flexible material in a first inflection period when the rolling unit 20 stops and then rotates again or in a second inflection period when the rolling unit 20 decelerates and then accelerates. When the winding roller 21 rotates n turns corresponding to the rotation number, the first rolling control step (S51) may be completed.

In addition, in the second rolling control step (S52), the winding roller 21 intermittently rotates in reverse one turn at a time in accordance with the rotation number, the other side of the flexible material slides intermittently in response to the intermittent reverse rotation of the winding roller 21, and the rolling unit 20 is intermittently raised in response to the intermittent reverse rotation of the winding roller 21. To be specific, in the second rolling control step (S52), the sliding unit 10 may intermittently move the other side of the flexible material away from the winding roller 21 in response to the operation of the rolling unit 20. In addition, in the second rolling control step (S52), the lifting unit 30 may intermittently raise the rolling unit in response to the thickness of the flexible material in a first inflection period when the rolling unit 20 stops and then rotates again or in a second inflection period when the rolling unit 20 decelerates and then accelerates. When the grip slider 12 returns to the original position thereof or the winding roller 21 rotates backwards n turns corresponding to the rotation number, the second rolling control step (S52) may be completed.

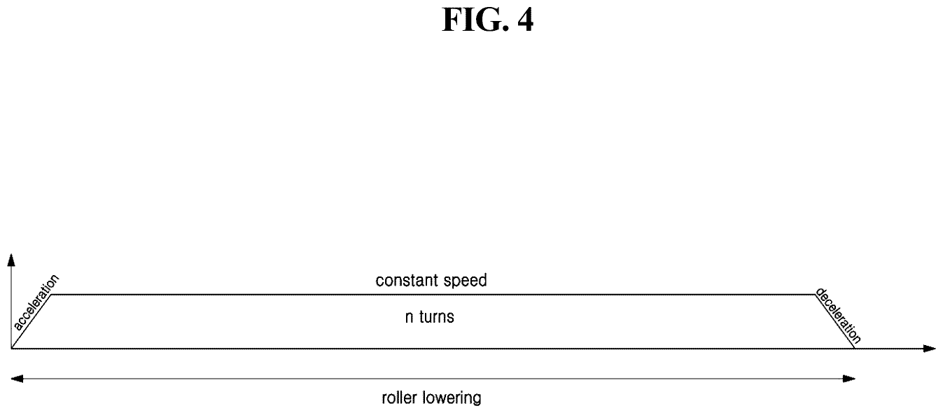

As another example, assuming that the calculated rotation number of the winding roller 21 is n turns, as shown in FIG. 4, in the first rolling control step (S51), the winding roller 21 continuously rotates in accordance with the rotation number, the other side of the flexible material slides continuously in response to the continuous rotation of the winding roller 21, and the rolling unit 20 is continuously lowered in response to the continuous rotation of the winding roller 21. To be specific, in the first rolling control step (S51), the sliding unit 10 may continuously move the other side of the flexible material toward the winding roller 21 in response to the operation of the rolling unit 20. In addition, in the first rolling control step (S51), the lifting unit 30 may continuously lower the rolling unit in response to the operation of the rolling unit 20. When the winding roller 21 rotates n turns corresponding to the rotation number, the first rolling control step (S51) may be completed.

In addition, in the second rolling control step (S52), the winding roller 21 continuously rotates in reverse one turn at a time in accordance with the rotation number, the other side of the flexible material slides continuously in response to the continuous reverse rotation of the winding roller 21, and the rolling unit 20 is continuously raised in response to the continuous reverse rotation of the winding roller 21. To be specific, in the second rolling control step (S52), the sliding unit 10 may continuously move the other side of the flexible material away from the winding roller 21 in response to the operation of the rolling unit 20. In addition, in the second rolling control step (S52), the lifting unit 30 may continuously raise the rolling unit in response to the operation of the rolling unit 20. When the grip slider 12 returns to the original position thereof or the winding roller 21 rotates backwards n turns corresponding to the rotation number, the second rolling control step (S52) may be completed.

According to the rolling test device for flexible materials described above, a rolling test device for flexible materials, which may prevent a flexible material from tilting between the sliding unit 10 and the rolling unit 20 and ensure that the tensile force applied to the flexible material is consistent when performing a rolling test of the flexible material, may be implemented.

Furthermore, a flexible material may be continuously maintained in a flat state, the tension of the flexible material may be adjusted, and uniform tension may be applied to the flexible material.

Furthermore, the initial setting of a flexible material may be clearly established, the operations of the rolling unit 20, the sliding unit 10, and the lifting unit 30 may be clearly linked, and wrinkling of the flexible material may be prevented.

Furthermore, it is possible to maintain a flexible material in a taut state, and to stably implement the rolling motion of the flexible material and the unrolling motion of the flexible material.

Furthermore, since the winding roller 21 moves up and down in conjunction with the operations of the rolling unit 20 and the sliding unit 10, tilting of a flexible material between the rolling unit 20 and the sliding unit 10 may be minimized or prevented, and the tensile force applied to the flexible material may be set consistently.

Furthermore, the winding roller 21 may be changed in various ways depending on a flexible material to be tested, and by interlocking the rolling unit 20, the sliding unit 10, and the lifting unit 30, the rotation of the winding roller 21, the lifting movement of the winding roller 21, and the sliding movement of a flexible material may be clearly performed, while improving the accuracy of the test results.

Furthermore, intermittent rotation of the winding roller 21 may be implemented depending on the rotation number of the winding roller 21, the change in inclination of a flexible material may be predicted in response to the thickness of the flexible material, and the test results may be easily corrected according to the inclination of the flexible material.

Furthermore, continuous rotation of the winding roller 21 may be be implemented depending on the rotation number of the winding roller 21, the flatness of the initially set flexible material may be maintained stably, and the test results according to the inclination of the flexible material may be easily corrected.

What is claimed is:

1. A rolling test device for flexible materials, the device comprising:
a rolling unit composed of a winding roller that grips a first side of a flexible material, and a winding drive part that rotates the winding roller forwards and backwards so that the flexible material is wound on the winding roller or the flexible material is unwound from the winding roller;
a sliding unit that grips a second side of the flexible material, is spaced apart from the winding roller, and slidably moves the flexible material according to rotation of the winding roller;
a lifting unit that moves the rolling unit up and down; and
a control unit that controls operations of the rolling unit, the sliding unit, and the lifting unit according to the rotation of the winding roller so that an inclination of the flexible material is adjusted between the rolling unit and the sliding unit.

2. The device of claim 1, wherein the sliding unit comprises:
a sliding guide disposed spaced apart from the winding roller;
a grip slider coupled to the sliding guide to be able to move slidably;
a detachable member that is provided on the grip slider and grips the second side of the flexible material; and
a sliding drive part that slidably moves the grip slider on the sliding guide according to the rotation of the winding roller.

3. The device of claim 1, wherein the lifting unit comprises:
a ball screw disposed spaced apart from the rolling unit and formed long along a lifting and lowering movement direction of the winding roller;
a screw driving part that rotates the ball screw forwards and backwards so that the winding roller moves up and down;
a lifting member screw-coupled to the ball screw; and
a lifting bracket that combines the rolling unit and the lifting member.

4. The device of claim 1, wherein the control unit comprises:
a condition input part where a length of the flexible material, a thickness of the flexible material, and a diameter of the winding roller are input as condition information;
a rotation number calculation part that calculates a rotation number of the winding roller on the basis of the condition information;
a rolling distance calculation part that uses the condition information and the rotation number to calculate a rolling distance at which the second side of the flexible material slides by the sliding unit according to the rotation number;
a lifting distance calculation part that uses the condition information and the rotation number to calculate a lifting distance by which the winding roller moves up and down according to the rotation number; and
a drive control part that controls the operations of the rolling unit, the sliding unit, and the lifting unit using the rotation number, the rolling distance, and the lifting distance so that the inclination of the flexible material is adjusted between the rolling unit and the sliding unit.
